(19) United States
(12) Patent Application Publication
(10) Pub. No.: US 2024/0228348 A1
(43) Pub. Date: Jul. 11, 2024

(54) USE OF POLYMERS OF ACRYLIC ACID FOR SCALE INHIBITION IN DESALINATION SYSTEMS

(71) Applicant: BASF SE, Ludwigshafen (DE)

(72) Inventors: Ahmet Uener, Ludwigshafen (DE); Stephan Nied, Ludwigshafen (DE); Juergen Detering, Ludwigshafen (DE); Achim Fessenbecker, Ludwigshafen (DE)

(21) Appl. No.: 18/561,441

(22) PCT Filed: May 23, 2022
(86) PCT No.: PCT/EP2022/063836

§ 371 Date: Nov. 16, 2023

(30) Foreign Application Priority Data
May 24, 2021 (EP) 21175531.9

(51) Int. Cl. C02F 5/14; C02F 103/08

(52) U.S. Cl. CPC C02F 5/14; C02F 2103/08; C02F 2209/02; C02F 2209/44

(57) ABSTRACT

The invention relates to the use of an aqueous solution of acrylic acid polymer for inhibiting scale formation in a desalination system, wherein the polymer of acrylic acid obtained by a process of polymerising acrylic acid in feed operation with a free radical starter in the presence of hypophosphite in water as solvent, which comprises (i) initially charging water and aqueous hypophosphite solution and optionally acrylic acid in acidic, unneutralised form, optionally one or more ethylenically unsaturated comonomers, and optionally initiator, (ii) adding acrylic acid in acidic, unneutralised form, optionally one or more ethylenically unsaturated comonomers, aqueous free radical starter solution and aqueous hypophosphite solution, (iii) adding a base to the aqueous solution after termination of the acrylic acid feed, wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.8 to 2, wherein the acrylic acid polymer has a weight average molecular mass Mw of from 1000 to 3000 g/mol, wherein the desalination system comprises at least one of the group consisting of Multi Stage Flash (MSF), at least one Multi Effect Distillation (MED) and Reverse Osmosis (RO). The invention also relates to a process of desalinating saline water in a desalination system.

### FIELD OF THE INVENTION

The present invention is in the field of preventing scale formation in desalination systems and relates to the use of acrylic acid polymers obtained by a particular polymerisation process to achieve this purpose. Such use enables a high-temperature desalination system to operate at a significantly higher temperature thereby improving efficiency. Further, such use enables a Reverse Osmosis (RO) desalination system to operate with improved anti-scaling and antifouling of the Reverse Osmosis (RO) membrane.

### BACKGROUND OF THE INVENTION

Desalination is a process which removes salts and other electrolytes from saline water. The process is employs high temperatures and is generally high energy consumptive and therefore desalinated water is typically more expensive to produce than natural sources of freshwater. Therefore, desalination is used in situations where natural fresh water sources are scarce. This can, for instance be on ships and submarines but mostly desalination is employed in terrestrial locations where freshwater from rivers, lakes and groundwater is not available. Most desalinated water is employed for human consumption or irrigation in agriculture.

Due to the high temperatures employed in desalination there is a risk of scale formation on hot surfaces of the desalination equipment. This is because the solubility of most substances in water is limited. Inorganic substances and salts such as calcium and magnesium carbonate, magnesium hydroxide, calcium and barium sulfate and calcium phosphate have a low solubility in water. If there is a concentration of these dissolved ingredients in aqueous systems (thickening), the solubility product is exceeded with the result that these substances fail and cause deposits. The solubility of the substances is additionally dependent on the temperature and the pH value. In particular, many substances such as calcium carbonate, calcium sulfate or magnesium hydroxide have an inverse solubility. This means that their solubility decreases with increasing temperature.

Precipitations and deposits of inorganic substances and salts in water-carrying systems should be avoided in particular, as they can only be removed with great effort. Any mechanical and dry cleaning is costly and time-consuming and inevitably leads to production failures.

In the desalination of seawater by distillation and by membrane processes such as reverse osmosis or electrodialysis, it is endeavored not to let these solid coverings arise. Especially in thermal seawater desalination plants, both effects play an important role, i.e. concentration by evaporation of water on the one hand and high process temperatures on the other.

Thermal desalination plants frequently employed include multi-effect distillation (MED) or multistage flash (MSF) distillation both of which involve heating the water to high temperatures.

Multiple effect distillation (MED) involves multiple effects involving heating incoming saline water by spraying on to heated pipes. Some of the water evaporates and the steam so formed flows into the tubes of the next stage effect which heats and evaporates more water. Thus, the steam is being used to heat the subsequent batch of incoming saline water. The hottest stage is usually the first stage and is typically operated at a temperature below 70 to 75° C. in order to avoid scale formation.

Multi-stage flash (MSF) distillation comprises distilling seawater by flashing part of the water into steam in multiple stages of effectively countercurrent heat exchangers. The normal operating temperature for MSF distillation is usually about from 90 to 110° C. Increasing the temperature may induce scale formation and corrosion such that the maximum temperature normally employed is from 110 to 120° C. although in many situations to avoid scale formation much lower temperatures would need to be employed, for instance below 70° C.

The productivity of thermal desalination plants is limited by the upper process temperature. It is desirable to operate thermal seawater desalination plants at the highest possible evaporation temperature in order to achieve the highest possible process efficiency.

This means that you want to minimize the energy required to produce fresh water. Frequently the characteristic kWh/m³ water is used for this purpose. This requires the highest possible process temperatures. However, these are mainly limited by the increasing formation of plaques with increasing temperature. It is known that in particular the deposition of basic magnesium salts such as magnesium hydroxide (brucit) and magnesium hydroxide magnesium carbonate (hydromagnesite), as well as calcium carbonate and calcium sulfate in thermal desalination plants play a critical role.

The productivity of membrane processes is, among others, limited by the formation of inorganic precipitations during the desalination process. It is important to operate membrane processes as far as possible without any downtimes in order to achieve the highest possible process efficiency. This means that the membrane system is to be operated for as long as possible, without interruptions for the removal of inorganic precipitations. In particular, deposits of calcium carbonate and calcium sulfate, in reverse osmosis desalination plants, play a critical role. Reverse osmosis processes generally employ spiral wound elements which consist of layers of membranes each separated by spacers. Purified water passes through each membrane before being passed from the wound element as purified water. Impurities that do not pass through one of the membranes are collected in the spacer. Generally, the impurities would be held as a concentrate. Typically, in the concentrated reject concentrated salts, particularly multivalent metal salts e.g. calcium salts, can precipitate and form scaling in the spacers. Such scaling can inhibit or block the flow of water passing through the spiral wound element thus impairing the performance of the reverse osmosis process. It would be desirable to provide a treatment to overcome this problem.

Various scale inhibition treatments for desalination systems have been proposed over the years.

GB 1218952 describes a process for desalinating saline water by evaporation, without substantial deposition of scale on the evaporator. A scale inhibiting concentration of polyacrylic acid, or a water-soluble salts thereof, having an average molecular weight from 1000 to 19,000, calculated as polyacrylic acid is maintained in the saline water. Water is evaporated and the so formed water vapour condensed and collected. The reference indicates that continuous vaporisation at temperatures of 85° F. to 350° F. (29.44° C. to 176.7° C.) is said to be obtained and excellent results at temperatures up to 260° F. (126.7° C.) observed with minimal deposits.

U.S. Pat. No. 4,164,521 describes composition for treating saline water being processed in evaporative desalination units in order to reduce scaling and sludge formation. The composition is said to comprise (1) a poly anionic polymer containing at least about 50 mol % of repeating units derived from acrylic acid and any balance of repeating units derived from one or more monomers compatible there with in which the acid units are selected from free acid radical, ammonium salt and alkali metal salts and (2) a polycationic polymer selected from various cationic polymer types. The composition is said to inhibit magnesium scale.

U.S. Pat. No. 4,175,100 reveals an anionic polymer of acrylamide having a skewed molecular weight distribution such that about 60% of the polymer has a molecular weight of about 500 to 2000 and about 10% of the polymer has a molecular weight from about 4000 to 12,000. This polymer is said to be useful for recirculating water systems, wireless and in evaporative and reverse osmosis desalination systems.

U.S. Pat. No. 4,634,532 teaches a process for controlling the formation and deposition of seawater scale, including calcium carbonate, on heat transfer surfaces contacting seawater at a temperature of at least about 200° F. (93° C.) in thermal desalination plants. A treatment is proposed comprising a water-soluble source of (a) orthophosphate; and (b) at least one water-soluble component selected from any of the following (1) polymers of maleic acid or anhydride having a weight average molecular weight less than 25,000; (2) phosphonates selected from either hydroxyethylidene diphosphonic acid and 2-phosphino-1,2,4-tricarboxy butane; (3) polymers comprising (i) acrylic acid or methacrylic acid and (ii) 2-acrylamido-2-methyl propane sulfonic acid having a weight average molecular weight of less than about 66,000 and the molar ratios of (i): (ii) ranges from about 98:2 to about 10:90; and (4) polyacrylic acids having a weight average molecular weight of less than about 25,000. The ratio of component (a): component (b) ranges from about 0.1:1 to about 10:1 and in which the pH of the water to be desalinated ranges from about 6.5 to about 9.5.

It is known that low molecular weight polyacrylic acids and their salts produced by means of radical polymerization are used as a surface preventer in industrial water treatment and in seawater desalination due to their dispersing and crystal growth inhibiting properties.

In order to achieve a satisfactory scale inhibition effect, the molecular weight mean (M_{w}) of polyacrylic acid polymers should be <50,000 g/mol. Polyacrylic acids with M_{w}<10,000 g/mol are often described as particularly effective. To produce low molecular polyacrylic acids, molecular weight regulators or chain carriers are added during the radical polymerization of acrylic acid. These regulators must be tuned to the polymerization initiator as well as to the polymerization process in order to produce the polymers as effectively as possible. Initiators are e.g. inorganic and organic per-compounds such as peroxodisulfates, peroxides, hydroperoxides and perester, azo compounds such as 2,2′ azobisisobutyronitrile, redox systems with inorganic and organic components. As regulators, inorganic sulfur compounds such as hydrogen sulphite, disulfite and dithionites, organic sulphides, sulfoxides, sulfones and mercapto compounds such as mercaptoethanol, mercaptoacetic acid as well as inorganic phosphorus compounds such as hypophosphoric acid (phosphine acid) and their salts (e.g. sodium hypophosphite) are often used.

US 2012/199783 describes low molecular weight containing polyacrylic acids and their use as scale inhibitors in water carrying systems. The invention is said to relate to an aqueous solution of acrylic acid polymers, obtainable by polymerisation of acrylic acid in feed mode with peroxydisulphate as initiator in the presence of hypophosphite in water as solvent. This involves (i) water and optionally one or more ethylenically unsaturated comonomers being initially charged, and (ii) acrylic acid in acidic, unneutralised form, optionally one or more ethylenically unsaturated comonomers, aqueous peroxydisulphate solution and aqueous hypophosphite solution being added continuously, and (iii) addition of a base on completion of the acrylic acid feed to the aqueous solution, wherein the comonomer content does not exceed 30% by weight, based on total monomer content.

WO 2012/104325 makes an analogous disclosure to US 2012/199783.

WO 2017134128 describes a method for producing aqueous solutions of acrylic acid polymers by polymerising acrylic acid feed mode with a radical starter in the presence of hypophosphite in water as a solvent. Water and optionally acrylic acid in acid, non-neutralised form, optionally one or more ethylenically unsaturated comonomers, optionally aqueous hypophosphite solution, and optionally initiator are introduced. Acrylic acid in acidic, non-neutralised form, optionally one or more ethylenically unsaturated comonomers, aqueous radical starter solution, and aqueous hypophosphite solution are added. After the end of the acrylic acid feed, a base is added to the aqueous solution, in which the comonomer content does not exceed 30% by weight with respect to the total monomer content. The acrylic acid, the aqueous radical starter solution, and the aqueous hypophosphite solution are added in such a way that, over a time. In which at least 75% of the acrylic acid is converted, the molar ratio x of acrylic acid to phosphorus-bonded hydrogen [AA]/[P—H] has a value x that is constant to ±0.5 and lies in the range of 0.8 to 2. The reference describes the need to provide dispersants for producing pigment slurries which may be used in a variety of industrial processes. The reference does, however, also describe that the polymers may be used as scale inhibitors in water carrying systems. Further the reference speculates that in thermal seawater desalination, the polymers are preferably used at 0.5 mg/l to 10 mg/l. However, this reference does not disclose that such thermal seawater desalination would comprise a distillation step at a temperature of at least 80° C. and does not disclose such distillation step operated at significantly higher temperatures than normally would be employed for that system nor is reverse osmosis mentioned.

US 2020/299426 relates to a process for producing aqueous solutions of acrylic acid polymers by polymerisation of acrylic acid in feed operation with a free radical starter in the presence of hypophosphite in water as solvent. The process involves (i) initially charging water and optionally acrylic acid in acidic, unneutralised form, optionally one or more ethylenically unsaturated comonomers, optionally aqueous hypophosphite solution and optionally initiator; (ii) adding acrylic acid in acidic, unneutralised form, optionally one or more ethylenically unsaturated comonomers, aqueous free radical starter solution an aqueous hypophosphite solution; and (iii) addition of a base to the aqueous solution after termination of the acrylic acid feed. The disclosure requires that the comonomer content not exceed 30 weight % based on total monomer content. The acrylic acid, the aqueous free radical starter solution an aqueous hypophosphite solution are added such that the molar ratio x of acrylic acid to phosphorus-bound hydrogen [AA]/[P—H] over a time period in which at least 75% of the acrylic acid is converted has a value x which is constant to within ±0.5 and is in the range from 0.8 to 2.

It would be desirable to provide products that are effective at inhibiting scale formation in desalination systems especially where such products provide anti-scaling and antifouling. Further, the aim is to provide such products that would be effective scale inhibitors in high-temperature desalination systems. It would be particularly desirable for such products to be used advantageously in multiple effect distillation (MED) and multi-stage flash distillation (MSF) systems. In addition, there is a desire for effective scale inhibitor products in Reverse Osmosis (RO) desalination systems and that advantageously will prevent scaling and fouling. It is a further objective to provide products that achieve effective or improved scale inhibition in desalination systems without adversely affecting dispersion capability of particles, salts or minerals. Reduced dispersion capability may result in interaction with evenly formed crystals and effect scale inhibition performance. Thus, a still further objective is to provide a product that will advantageously inhibit scale formation by comparison to other known polyacrylic acid scale inhibitors and at the same time either equal or improve upon the dispersion capability of particles, salts or minerals present in the water.

### SUMMARY OF THE INVENTION

The first aspect of present invention provides the use of an aqueous solution of acrylic acid polymer for inhibiting scale formation in a desalination system, wherein the polymer of acrylic acid obtained by a process of polymerising acrylic acid in feed operation with a free radical starter in the presence of hypophosphite in water as solvent, which comprises
(i) initially charging water and aqueous hypophosphite solution and optionally acrylic acid in acidic, unneutralised form, optionally one or more ethylenically unsaturated comonomers and optionally initiator,
(ii) adding acrylic acid in acidic, unneutralised form, optionally one or more ethylenically unsaturated comonomers, aqueous free radical starter solution an aqueous hypophosphite solution,
(iii) adding a base to the aqueous solution after termination of the acrylic acid feed, wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.8 to 2,
wherein the acrylic acid polymer has a weight average molecular mass M_{w} from 1000 to 3000 g/mol, preferably from 1000 to 2500 g/mol, wherein the desalination system comprises at least one of the group consisting of Multi Stage Flash (MSF), at least one Multi Effect Distillation (MED) and Reverse Osmosis (RO).

According to a second aspect of the invention we provide a process of desalinating saline water in a desalination system comprising:
a) adding an aqueous solution of acrylic acid polymer for inhibiting scale formation in the desalination system;
b) subjecting the saline water to at least one desalination step, wherein the polymer of acrylic acid obtained by a process of polymerising acrylic acid in feed operation with a free radical starter in the presence of hypophosphite in water as solvent, which comprises
   (i) initially charging water and aqueous hypophosphite solution and optionally acrylic acid in acidic, unneutralised form, optionally one or more ethylenically unsaturated comonomers and optionally initiator,
   (ii) adding acrylic acid in acidic, unneutralised form, optionally one or more ethylenically unsaturated comonomers, aqueous free radical starter solution an aqueous hypophosphite solution,
   (iii) adding a base to the aqueous solution after termination of the acrylic acid feed,
wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.8 to 2, wherein the acrylic acid polymer has a weight average molecular mass M_{w} of from 1000 to 3000 g/mol, preferably from 1000 to 2500 g/mol, wherein the desalination system comprises at least one of the group consisting of Multi Stage Flash (MSF), at least one Multi Effect Distillation (MED) and Reverse Osmosis (RO).

### DETAILED DESCRIPTION OF THE INVENTION

The inventors have discovered that polymers of acrylic acid which are obtained by the procedure set out in the summary of the invention and crucially having a weight average molecular mass M_{w} of from 1000 to 3000 g/mol, preferably from 1000 to 2500 g/mol, are particularly effective at inhibiting scaling in desalination processes. In one alternative form the weight average molecular mass M_{w} may be from 1500 to 3000 g/mol, suitably from 1500 to 2500 g/mol This is particularly so on hot surfaces where the desalination process employs high temperatures and in particular a distillation step. This is so much so that the inventive use and method can facilitate such desalination processes to be operated at temperatures higher than typically practised in the industry. The invention is also useful for other desalination processes, for instance reverse osmosis (RO) where it is important that scaling is inhibited in order to prevent scaling of spiral wound elements, typically scale deposition in the spacers and the risk of fouling of filter membranes.

Inorganic substances, such as inorganic salts, present in seawater are prone to precipitation and hence scaling during desalination processes. The present invention offers an effective way of reducing or minimising scale formation. This is the case for a variety of dissolved inorganic substances present in seawater, for instance inorganic salts, such as calcium carbonate, magnesium carbonate, magnesium hydroxide, calcium sulfate, barium sulfate, calcium phosphate, magnesium silicate, calcium silicate and silica. Suitably the invention can inhibit scale formation resulting from calcium salts and/or magnesium salts present in the desalination system. This is especially the case for inhibiting scale formation in the desalination system resulting from calcium sulfate.

The use and method of the present invention is particularly useful where the desalination system is a high-temperature desalination system, specifically where the desalination system comprises at least one of the group consisting of Multi Stage Flash (MSF), Multi-Effect Distillation (MED). In general, the productivity of thermal desalination plants is limited by the upper process temperature. Although scale inhibitors based on low molecular weight polyacrylic acids are known, the polymers of acrylic acid prepared by the precise process given in the summary of the invention having specifically weight average molecular weights M_{w} from 1000 to 3000 g/mol, preferably from 1000 to 2500 g/mol, have now been found to be particularly effective for such high-temperature desalination systems and reverse osmosis desalination systems. Alternatively, the weight average molecular weights M_{w} may be from 1500 to 3000 g/mol, preferably from 1500 to 2500 g/mol.

Specifically, the use and method according to the present invention is also particularly effective where the desalination system comprises Reverse Osmosis (RO).

The use and method permit the upper process temperature to be higher without any significant increase in scaling, thus allowing the desalination process to operate more effectively. This is particularly so in the desalination systems Multi-Stage Flash (MSF) and Multi-Effect Distillation (MED). The desalination system may be run at a temperature which is 10% higher, preferably at least 50% higher, than the standard mean temperature adopted for that desalination system. The exact temperature selected will generally depend on the particular desalination system.

Multi-Stage Flash (MSF) tend to operate at somewhat higher temperatures than for Multi-Effect Distillation (MED). Even within one category of desalination systems, different plants may operate at slightly different temperatures which may depend upon the particular confirmation and layout of that system.

Multi-Stage Flash (MSF) desalination processes normally operate at temperatures of about 110° C. The inventive use and method enable such Multi-Stage Flash (MSF) processes to operate at significantly high temperatures. Desirably the Multi-Stage Flash (MSF) can be operated at a temperature of at least 112° C., suitably at least 120° C. This can be even higher, for instance at least 125° C. and more desirably at least 130° C. or even at least about 140° C. For instance, and MSF process that would normally operate at 110° C. may be able to operate at temperatures of 140° C. using the present invention. These temperatures can be sustained without any significant deleterious scaling. This is particularly in the avoidance of calcium salts, for instance calcium carbonate and especially calcium sulfate.

Multi-Effect Distillation (MED) desalination processes normally operate at temperatures of about 65° C. The inventive use and method facilitate such Multi-Effect Distillation (MED) processes to be operated at temperatures of at least 70° C., suitably at least 75° C., more suitably at least 80° C., preferably at least 85° C. and can even be run quite comfortably at temperatures of around 90° C. or even higher. Deleterious effects of scaling can be avoided while operating at these high temperatures. This is the case especially for calcium salts, such as calcium carbonate and particularly calcium sulfate.

In another important embodiment, the present invention may be used in a Reverse Osmosis (RO) desalination system. Reverse Osmosis tend to comprise a Reverse Osmosis (RO) membrane. Typically, the RO membrane process uses semipermeable membranes and applied pressure on the feed side of the membrane such that water permeation is preferentially induced through the membrane while rejecting salts. Reverse Osmosis systems tend to use less energy than thermal desalination processes. As such, the energy costs of Reverse Osmosis desalination systems can be lower than high-temperature desalination systems. However, the RO membrane elements have a tendency to become fouled. Typically, the RO membrane elements are known as spiral wound elements consisting of layers of the membranes each separated by spacers. Generally, the scaling occurs in the spacers or can foul membrane surfaces which can inhibit the flow of water through the spiral wound element thus impairing the performance of the reverse osmosis process. In order to avoid this, it is common practice to employ scale inhibitors and common scale inhibitors employed for this purpose include low molecular weight polyacrylic acids. Nevertheless, scaling can still occur, particularly with multivalent metal salts and especially calcium salts such as calcium carbonate and more especially calcium sulfate.

The inventive use and method significantly inhibit scale formation in a Reverse Osmosis (RO) desalination system. This is especially so for calcium salts and particularly effectively for as calcium carbonate and calcium sulfate.

The use employs the polymer of acrylic acid as defined in accordance with the description of the invention. This polymer of acrylic acid may be used as the sole scale inhibition additive or in conjunction with other scale inhibition chemicals. In most cases it would be suitable to use the polymer of acrylic acid according to the present invention as the sole additive or at least main scale inhibiting additive. Nevertheless, in some cases it may be desirable to use other scale inhibitors as co-additives with the acrylic acid polymer of the invention. Typical co-additive scale inhibitors may include comb polymers, which may be (meth)acrylic acid copolymers carrying pendant polyalkylene oxide groups; polymers carrying sulfonic acid groups, such as copolymers of acrylic acid and/or acrylamide with 2-acrylamido-2-methyl propane sulfonic acid; homopolymers of acrylic acid or copolymers of acrylic acid with acrylamide. Usually, such co-additive polymers would have a weight average molecular weights (M_{w}) below 12,000 g/mol, typically in the range from 2500 g/mol to 10,000 g/mol.

When a co-additive scale inhibitor is used in conjunction with the acrylic acid polymer according to the invention, they may be added either sequentially or simultaneously but separately. Nevertheless, it may be particularly desirable to employed the co-additive scale inhibitor and acrylic acid polymer of the invention as a blend.

It is essential to the invention that the polymer of acrylic acid is obtained by a process of polymerising acrylic acid in feed operation with a free radical starter in the presence of hypophosphite in water as solvent. This process comprises the steps of
(i) initially charging water and aqueous hypophosphite solution and optionally acrylic acid in acidic, unneutralised form, optionally one or more ethylenically unsaturated comonomers and optionally initiator,
(ii) adding acrylic acid in acidic, unneutralised form, optionally one or more ethylenically unsaturated comonomers, aqueous free radical starter solution an aqueous hypophosphite solution,
(iii) adding a base to the aqueous solution after termination of the acrylic acid feed.

The comonomer content should not exceed 30 wt. % based on the total monomer content. It is important that the acrylic acid, the aqueous free radical starter solution and the aqueous hypophosphite solution are added such that the molar ratio x of acrylic acid to phosphorus-bound hydrogen [AA]/[P—H] over a time period in which at least 75%, suitably at least 80%, desirably at least 85%, of the acrylic acid is converted and has a value x which is constant to within ±0.5 and is in the range from 0.8 to 2. Crucially the acrylic acid polymer has a weight average molecular mass M_{w} from 1000 to 3000 g/mol, preferably 1000 to 2500 g/mol. Alternatively, the weight average molecular weights M_{w} may be from 1500 to 3000 g/mol, preferably from 1500 to 2500 g/mol.

The inventors believe that it is the combination of polyacrylic acid having a particular molecular structure resulting from the specific process of preparation with the specific narrow molecular weight range that brings about the significantly improved scale inhibition effects in desalination processes.

Preferably a portion of the total aqueous hypophosphite solution employed in the process is included in the process as a preload before the introduction of any monomer and optionally before the introduction of initiator. Thus preferably, step (i) would not include acrylic acid nor one or more ethylenically unsaturated comonomers. Step (i) may be defined as initially charging only water and aqueous hypophosphite solution and optionally initiator. More preferably, step (i) comprises charging water, aqueous hypophosphite solution and initiator in the absence of acrylic acid and in the absence of one or more ethylenically unsaturated comonomers.

Suitably the portion of the total aqueous hypophosphite solution included in step (i) as a preload may be in the range of from 0.5% to 10.0% based on the total dry weight of hypophosphite added. Desirably, this may be in the range from 1.0% to 6.0%, and more desirably from 2.0% to 5.0%.

Preferably initiator may be included in step (i) with the hypophosphite as the preload. Generally, the initiator may be the same compound as the free radical starter used in step (ii). The amount of initiator added into the preload may be from 0.25 to 5% of the total amount of free radical starter used in step (ii) based on the dry weight of initiator and dry weight of free radical starter. Desirably the amount of initiator may be from 0.5 to 3% of the total amount of free radical starter, more desirably from 1% to 2%.

A preferred form of the first aspect of the invention provides the use of an aqueous solution of acrylic acid polymer for inhibiting scale formation in a desalination system, wherein the polymer of acrylic acid obtained by a process of polymerising acrylic acid in feed operation with a free radical starter in the presence of hypophosphite in water as solvent, which comprises
(i) initially charging water and aqueous hypophosphite solution and optionally initiator,
(ii) adding acrylic acid in acidic, unneutralised form, optionally one or more ethylenically unsaturated comonomers, aqueous free radical starter solution an aqueous hypophosphite solution,
(iii) adding a base to the aqueous solution after termination of the acrylic acid feed,
   wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.8 to 2, wherein the acrylic acid polymer has a weight average molecular mass M_{w} from 1000 to 3000 g/mol, preferably from 1000 to 2500 g/mol, wherein the desalination system comprises at least one of the group consisting of Multi Stage Flash (MSF), at least one Multi Effect Distillation (MED) and Reverse Osmosis (RO).

The preferred form of the second aspect of the invention provides a process of desalinating saline water in a desalination system comprising:
a) adding an aqueous solution of acrylic acid polymer for inhibiting scale formation in the desalination system;
b) subjecting the saline water to at least one desalination step,
wherein the polymer of acrylic acid obtained by a process of polymerising acrylic acid in feed operation with a free radical starter in the presence of hypophosphite in water as solvent, which comprises
   (i) initially charging water and aqueous hypophosphite solution and optionally initiator,
   (ii) adding acrylic acid in acidic, unneutralised form, optionally one or more ethylenically unsaturated comonomers, aqueous free radical starter solution an aqueous hypophosphite solution,
   (iii) adding a base to the aqueous solution after termination of the acrylic acid feed,
wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.8 to 2, wherein the acrylic acid polymer has a weight average molecular mass M_{w} of from 1000 to 3000 g/mol, preferably from 1000 to 2500 g/mol, wherein the desalination system comprises at least one of the group consisting of Multi Stage Flash (MSF), at least one Multi Effect Distillation (MED) and Reverse Osmosis (RO).

The molar ratio x of acrylic acid to free-radically abstractable, phosphorus-bound hydrogen [AA]/[P—H] over a period in which at least 75%, suitably at least 80%, desirably at least 85%, of the acrylic acid is converted is thus not less than 0.8±0.5 (i.e. can vary from 0.3 to 1.1 over this time period) and not more than 2.0±0.5 (i.e. can vary from 1.5 to 2.5 over this time period) according to the invention.

In a preferred embodiment of the invention, the molar ratio x of acrylic acid to free-radically abstractable, phosphorous-bound hydrogen [AA]/[P—H] is 1.0±0.5. The free-radically abstractable, phosphorus-bound hydrogen is to be understood as meaning covalent hydrogen-phosphorus bonds present in the employed sodium hypophosphite (1) or in the hypophosphite terminally bound to the polymer chain (2).

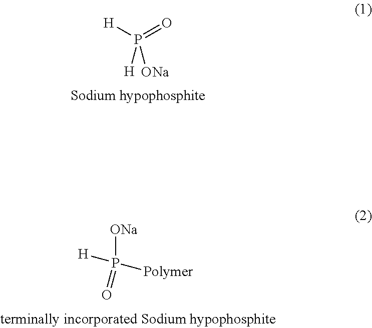

Sodium hypophosphite and incorporated hypophosphite may be present in water in dissociated form, without sodium as a counterion, and in protonated form.

The process generally comprises adding continuously at a constant or varying dosing rate or discontinuously (portionwise) to an initial charge comprising water as solvent containing aqueous hypophosphite solution and optionally initiator a total amount m¹ of acrylic acid over a time period (t1−t1.0), a total amount m² of free-radical starter solution over a time period (t2−t2.0) and a total amount m³ of aqueous hypophosphite solution over a time period (t3−t3.0). The polymerization takes place in the stirred reaction vessel in the time period (t4−t4.0), wherein the time point t4.0 determines commencement of the polymerization. The time point t1 determines the end of the acrylic acid addition, t2 determines the end of the starter addition, t3 determines the end of the regulator addition and t4 determines the end of the polymerization reaction, including the post polymerization in the time period from t1 to t4.

A kinetic model for the copolymerization of acrylic acid in the presence of hypophosphite was used to calculate how by varying the hypophosphite dosing the residual amount of regulator, m³′, not incorporated into the polymer at the end of polymerization t4 can be reduced while leaving the process otherwise unchanged. The residual amount of regulator m³′ has no covalent bond with the polymer (C—P bond) and is therefore hereinbelow referred to as inorganic phosphorus.

It may be present in the form of the employed regulator (1) or in other oxidation states of hypophosphite such as phosphonic acid or phosphoric acid for example. Also possible are the dissociated, protonated and structurally isomerized forms of the respective oxidation states.

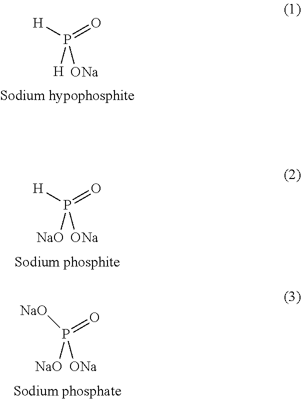

The amount of inorganic phosphorus, m³′ and the proportion m³′/m³ decrease with decreasing selected feed time for the hypophosphite regulator t3−t3.0. Likewise, the amount of inorganic phosphorus m³′ decreases with increasing proportional amount of hypophosphite regulator added early within the total regulator dosing time t3−t3.0. Also, m³′ decreases as the total amount of dosed regulator m³ in the formulation is reduced. A suitable measure of the time averaged dosing time point for the regulator is provided by the following parameter:

$${\overline{t}}_{dosing} = \frac{1}{m 3} {\int }_{t 3.}^{t 3} ( d ( t ) * t ) dt$$

Here, t is the time from t3.0 to t3, d(t) is the dosing rate (units of mass/time) of the regulator at time point t. The time-averaged dosing time point describes the addition of the total regulator amount as a time-based average.

For the sake of elucidation, two examples for different regulator dosing of a particular amount of regulator m³, including the initially charged regulator amount, in a particular dosing time (t3−t3.0) are reported:
a) For example, an addition of the regulator at a constant dosing rate during the entire time of the regulator dosing (t3−t3.0) results in an average dosing time point of t̅_{dosing}=(t3−t3.0)/2.
b) For example, a higher dosing rate in the interval [t3.0−(t3−t3.0)/2] (compared to the dosing rates in a)) and a dosing rate reduced by the same amount in the interval [(t3−t3.0)/2−t3] results in an average dosing time point of t̅_{dosing}<(t3−t3.0)/2

In a preferred embodiment of the invention all feeds commence at the same time point to, i.e. t1.0=t2.0=t3.0=t0.

In this specific case the ratio of the time-averaged dosing time point for the regulator to the total dosing time for the acrylic acid (t1−t1.0) is <0.49, preferably <0.47, particularly preferably 0.3 to 0.47.

The ratio of the average dosing time point for the regulator to the total dosing time for the regulator is moreover generally <0.5, preferably ˜ 0.45, particularly preferably from 0.3 to 0.45. The feeding of the hypophosphite regulator may be effected continuously or discontinuously in discrete amounts m31, m32, m33 etc. at discrete time points t31, t32, t33 etc. until time point t3.

It is evident that the molecular weight distribution is preserved despite the reduction in the amount of inorganic phosphorus (m³′) when the molar ratio of the concentrations of free-radically abstractable phosphorus-bound hydrogen and acrylic acid [AA]/[P—H] momentarily present in the reaction vessel is kept constant in the range from 0.8 to 2.0±0.5, suitably from 0.9 to 1.1±0.5, preferably 1.0±0.5, over a time period in which at least 75%, suitably at least 80%, desirably at least 85%, of the monomer conversion is effected by controlling the process parameters. A reduction in the conversion range during which the ratio of acrylic acid to phosphorus-bound hydrogen kept constant can result in a broadening of the molecular weight distribution. The deviation from the preferred value [AA]/[P—H]=1.0±0.5 should be as low as possible, even outside the limits of a monomer conversion of at least 75%, suitably at least 80%, desirably at least 85%, to obtain a narrow molecular weight distribution. The value of [AA]/[P—H] outside the conversion range of 75% must always be less than [AA]/[P—H]=4.5.

In a preferred embodiment the molar ratio of acrylic acid to phosphorus-bound hydrogen [AA]/[P—H] over a time period in which at least 80% of the acrylic acid is converted is 1.0±0.5.

The maximum value of [AA]/[P—H] outside the range of 80% of the acrylic acid conversion is not more than 4.5.

In a particularly preferred embodiment, the molar ratio of acrylic acid to phosphorus-bound hydrogen [AA]/[P—H] over a time period in which at least 80%, desirably at least 85%, of the acrylic acid is converted is suitably from 0.9 to 1.1±0.25, more preferably 1.0±0.25. The maximum value of [AA]/[P—H] outside the range of 80% of the acrylic acid conversion is not more than 4.5.

Desirably, the value for the molar ratio [AA]/[P—H] should be smaller than 1.5 to result in number average molar masses smaller than Mn=2000 g/mol.

It is also evident that the average molar mass Mn of the polymer distribution increases linearly with the ratio [AA]/[P—H] and that the distribution breadth (measured with PDI=M_{w}/Mn) increases to values above PDI=1.7 when a particular ratio [AA]/[P—H] is not kept constant over a large part of the monomer conversion (>75%), suitably at least 80%, desirably at least 85%. This concentration ratio is obtainable by kinetic modeling or by experimental methods.

The ratio [AA]/[P—H] may be determined experimentally. Preference is given to a number average molar mass Mn of below-2000 g/mol.

Controlling the polymerization process via the parameter [AA]/[P—H] is decisive for adjusting the molecular weight distribution since this parameter determines the kinetic chain length of the polymers. Methods for controlling [AA]/[P—H] include not only the modeling method but also experimental methods such as spectroscopy: NMR, infrared vibrational spectroscopy and inline Raman spectroscopy. Analysis of samples taken during the polymerization is also suitable.

Here, sampling is effected in a provided inhibitor solution. Concentrations of acrylic acid present may be determined by HPLC, NMR spectroscopy or GC. The concentration of the P—H functionalities present may be determined by 31-P{1H} NMR spectroscopy.

The total feed time for the acrylic acid is generally 80 to 500 min, preferably 100 to 400 min.

The comonomers may be initially charged in the reaction batch, partly initially charged and partly added as a feed or exclusively added as a feed. When said comonomers are partly or completely added as a feed they are generally added simultaneously with the acrylic acid.

Water is generally added and heated to the reaction temperature of at least 75° C., preferably 90° ° C. to 115° C., particularly preferably 95° C. to 105° C.

An aqueous solution of phosphorous acid as corrosion inhibitor may also be initially charged.

The continuous feeds of acrylic acid, optionally of ethylenically unsaturated comonomer, starter and regulator are then started. Acrylic acid is added in unneutralized, acidic form. The feeds are generally started simultaneously. Both peroxodisulfate as starter and hypophosphite as regulator are employed in the form of their aqueous solutions.

Hypophosphite may be employed in the form of hypophosphorous acid (phosphinic acid) or in the form of salts of hypophosphorous acid. Hypophosphite is particularly preferably employed as hypophosphorous acid or as the sodium salt. Hypophosphite may be exclusively added as feed or partly initially charged. The hypophosphite content of the aqueous hypophosphite solution is preferably 35 to 70 wt. %.

It is preferable when hypophosphite is employed in amounts of at least 7.5 wt. %, based on the dry weight of the hypophosphite on the total dry weight of monomers. Preferably, this will be from 7.5 to 20.0 wt. %, more preferably from 8.0 to 17.0 wt. %, particularly preferably from 8.5 to 14.0 wt. %, especially from 9.0 to 12.0 wt. % based on the dry weight of hypophosphite on the total dry weight of monomers.

A preferred free-radical starter is peroxodisulfate. Peroxodisulfate is generally employed in the form of the sodium, potassium or ammonium salt. The concentration of a preferably used aqueous peroxodisulfate solution is 5 to 10 wt. %.

Peroxodisulfate is preferably employed in amounts of from 0.05 to 10 wt. %, or 0.1 to 10 wt. %, more preferably from 0.3 to 5 wt. %, particularly preferably from 0.5 to 3 wt. %, for instance from 0.5 to 2 wt. %, based on the total of dry weight of monomers (acrylic acid and optionally comonomers). Another particularly suitable range may be from 0.1 to 1.5 wt. %, such as from 0.1 to 1 wt. %, including from 0.1 to 0.3 wt. %.

It is further possible to employ hydrogen peroxide as the free-radical starter, for example in the form of a 50% aqueous solution. Also suitable are redox initiators based on peroxides and hydroperoxides and reducing compounds, for example hydrogen peroxide in the presence of iron(II) sulfate and/or sodium hydroxymethanesulfinate.

The duration of the starter feed may be up to 50% longer than the duration of the acrylic acid feed. The duration of the starter feed is preferably about 3 to 20% longer than the duration of the acrylic acid feed. The total duration of the regulator feed is preferably equal to the duration of the acrylic acid feed. The total duration of the regulator feed is generally from equal to the duration of the acrylic acid feed to up to 50% shorter or longer than the duration of the acrylic acid feed.

The duration of the monomer feed or—when a comonomer is used—of the monomer feeds is, for example, 2 to 5 h. For example, when all feeds start simultaneously the regulator feed ends 10 to 30 min before the end of the monomer feed and the starter feed ends 10 to 30 min after the end of the monomer feed.

A base is generally added to the aqueous solution after termination of the acrylic acid feed. This at least partly neutralizes the acrylic acid polymer formed. Partly neutralized means that only some of the carboxyl groups presents in the acrylic acid polymer are in the salt form. Generally, sufficient base is added to ensure that the pH is subsequently in the range from 3 to 8.5, preferably 4 to 8.5, in particular 4.0 to 5.5 (partly neutralized), or 6.5 to 8.5 (completely neutralized). The base used is preferably aqueous sodium hydroxide solution. It is also possible to employ ammonia or amines, for example triethanolamine. The thus achieved degree of neutralization of the polyacrylic acids obtained is between 15% and 100%, preferably between 30% and 100%. The neutralization is generally effected over a relatively long time period of, for example, ½ to 3 hours in order that the heat of neutralization may be readily removed.

The reaction is generally carried out under an inert gas atmosphere. Typically, this may be a nitrogen atmosphere. This affords acrylic acid polymers where the terminally bound phosphorus is present essentially (generally to an extent of at least 90%) in the form of phosphinate groups.

In a further variant an oxidation step is carried out after termination of the polymerization. The oxidation step converts terminal phosphinate groups into terminal phosphonate groups. The oxidation is generally effected by treatment of the acrylic acid polymer with an oxidant, preferably with aqueous hydrogen peroxide solution.

Aqueous solutions of acrylic acid polymers having a solids content of generally at least 30 wt. %, preferably at least 35 wt. %, particularly preferably 40 to 70 wt. %, in particular 50 to 70 wt. %, of polymer are obtained.

The acrylic acid polymers obtainable in accordance with the invention have a total phosphorus content of organically and possibly inorganically bound phosphorus, wherein
(a) a first part of the phosphorus is present in the form of phosphinate groups bound in the polymer chain,
(b) a second part of the phosphorus is present in the form of phosphinate and/or phosphonate groups bound at the polymer chain-end,
(c) possibly a third part of the phosphorus is present in the form of dissolved inorganic salts of phosphorus,
and generally, at least 86% of the total phosphorus content is present in the form of phosphinate or phosphonate groups bound in the polymer chain or at the polymer chain-end.

Preferably at least 88%, particularly preferably at least 90%, of the total phosphorus content is present in the form of phosphinate groups bound in the polymer chain or at the polymer chain-end. A particularly high content of phosphorus bound in the polymer chain is obtained on account of the feed operation according to the invention.

Generally, not more than 15%, preferably not more than 10%, of the phosphorus is present in the form of dissolved inorganic phosphorus salts. It is particularly preferable when 0% to 10% and in particular 0% to 6% of the phosphorus is present in the form of dissolved inorganic phosphorus salts.

Based on the mass of the polymers the amount of dissolved inorganic phosphorus salts is preferably ≤0.5 wt. %.

The weight-average molecular weight M_{w} of the acrylic acid polymer should be from 1000 to 3000 g/mol, preferably from 1000 to 2500 g/mol, more preferably from 1000 to 2300 g/mol, particularly preferably from 1000 to 2100 g/mol, in particular from 1000 to 2000 g/mol and specifically from 1000 to 1900 g/mol. The molecular weight can be selectively adjusted within these ranges via the employed regulator amount.

Alternatively, the weight-average molecular weight M_{w} of the acrylic acid polymer may be from 1500 to 3000 g/mol, suitably from 1500 to 2500 g/mol, more suitably from 1500 to 2300 g/mol, such as from 1600 to 2100 g/mol, or from 1600 to 2000 g/mol or specifically from 1700 to 1900 g/mol. Similarly, the molecular weight can be selectively adjusted within these ranges via the employed regulator amount.

The proportion of polymers having a weight-average molecular weight M_{w} of >40,000 g/mol is generally less than 3 wt. %, preferably less than 1 wt. %, particularly preferably less than 0.5 wt. %, based on total polymer.

The acrylic acid polymer generally has a polydispersity index M_{w}/Mn of <2.0, preferably from 1.3 to 1.8, for example from 1.4 to 1.7.

The acrylic acid polymer may be characterised in terms of its K value. Typically, the K value may be no more than 18. For instance, the K value may be from 12 to 18, from 13 to 17 and suitably from 14 to 16. The K value of the acrylic acid polymer may be determined according to H. Fikentscher, Cellulose-Chemie, volume 13, 58-64 and 71-74 (1932) in 5% strength aqueous sodium chloride solution at a pH of 7, a polymer concentration of 0.5% by weight and a temperature of 25° C.

The acrylic acid polymer may comprise up to 30 wt. %, preferably up to 20%, particularly preferably up to 10 wt. %, based on all ethylenically unsaturated monomers, of copolymerized ethylenically unsaturated comonomers. Examples of suitable ethylenically unsaturated comonomers are methacrylic acid, maleic acid, maleic anhydride, vinylsulfonic acid, allylsulfonic acid and 2-acrylamido-2-methylpropanesulfonic acid (AMPS) and salts thereof. Mixtures of these comonomers may also be present.

Particular preference is given to acrylic acid homopolymers without a comonomer proportion.

In one preferred embodiment of the use according to the invention, the polymer of acrylic acid is obtained by a process of polymerising acrylic acid in feed operation with a free radical starter in the presence of hypophosphite in water as solvent, which comprises
(i) initially charging water and aqueous hypophosphite solution and optionally initiator,
(ii) adding acrylic acid in acidic, unneutralised form, optionally one or more ethylenically unsaturated comonomers, aqueous free radical starter solution and aqueous hypophosphite solution,
(iii) adding a base to the aqueous solution after termination of the acrylic acid feed,
wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.9 to 1.1, preferably 1.0,
wherein the acrylic acid polymer has a weight average molecular mass M_{w} of from 1000 to 2500 g/mol, wherein the desalination system comprises at least one of the group consisting of at least one

Multi Stage Flash (MSF) which is operated at a temperature of at least 112° C., preferably at least 120° ° C.;
at least one Multi Effect Distillation (MED) which is operated at a temperature of at least 70° C., preferably at least 80° C.; and
Reverse Osmosis (RO) comprising a Reverse Osmosis (RO) membrane. This may be interpreted as step (i) not including acrylic acid nor one or more ethylenically unsaturated comonomers. Hence, step (i) may be defined as initially charging only water and aqueous hypophosphite solution and optionally initiator.

In another preferred embodiment of the use according to the present invention the polymer of acrylic acid is obtained by a process of polymerising acrylic acid in feed operation with a free radical starter in the presence of hypophosphite in water as solvent, which comprises
(i) initially charging water and aqueous hypophosphite solution and initiator,
(ii) adding acrylic acid in acidic, unneutralised form, optionally one or more ethylenically unsaturated comonomers, aqueous free radical starter solution and aqueous hypophosphite solution,
(iii) adding a base to the aqueous solution after termination of the acrylic acid feed,
wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.25 and is 1.0, wherein the acrylic acid polymer has a weight average molecular mass M_{w} of from 1000 to 2500 g/mol, wherein the desalination system comprises at least one of the group consisting of Multi Stage Flash (MSF) which is operated at a temperature of at least 120° C.; at least one Multi Effect Distillation (MED) which is operated at a temperature of at least 80° C.; and Reverse Osmosis (RO) comprising a Reverse Osmosis (RO) membrane. This may be interpreted as step (i) not including acrylic acid nor one or more ethylenically unsaturated comonomers and nor Initiator. Hence, step (i) may be defined as initially charging water and aqueous hypophosphite solution and initiator.

The following examples illustrate the invention.

### Examples

### Polymers Used in Examples 1 and 2

The following acrylic acid polymer samples were prepared by polymerising acrylic acid by the process specified in the examples of WO 2017134128 given on pages 13-15 with the mass of acrylic acid, sodium hypophosphite (SHP) and sodium persulphate given in Table 1 below and specific procedure parameters and polymer characteristics are provided in Table 2 below.

TABLE 1

| | | SHP (g); [%] based | Sodium persulphate |
|---|---|---|---|
| Polymer | Acrylic | on mass of acrylic | (g); [%] based on |
| Sample | Acid (g) | acid | mass of acrylic acid |
| Product A | 1251.0 | 123.56; [9.88] | 13.35; [1.07] |
| Product B | 1251.4 | 123.60; [9.88] | 13.35; [1.07] |
| Product C | 1114.2 | 73.88; [6.63] | 12.27; [1.10] |
| Product D | 1125.1 | 40.64; [3.61] | 12.52; [1.11] |
| Product E | 645.2 | 19.38; [3.00] | 7.1; [1.10] |

Product A and Product B are both polymers of acrylic acid that would fall into the scope of claim 1. Product A was prepared by controlling the acrylic acid feed employing a Raman probe and Product B was prepared using a linear feed rate of acrylic acid. Specific details of the preparations for Product A and Product B are shown below after Table 2.

The remaining 3 polymer samples Product C, Product D and Product E are comparative.

TABLE 2

| | average | | | | | |
|---|---|---|---|---|---|---|
| | dosing | | | | conversion | |
| | time point | | | | where | |
| | of the | | | | [AA]/ | residual |
| | regulator | | total SHP | Mn; Mw | [P − H] = | acrylic |
| Polymer | (t̅_{dosing}) * | (t̅_{dosing})/ | (g); total | [g/mol] | XX ± 0.5 | acid |
| Sample | in (s) | t1 − t1.0 | AA (g) | (PDI) | applies | [ppm] |
| Product A | 20,100 | 0.92 | 124; 1251 | 1147; | 85% | 128 |
| | | | | 1783 | (0.966) | |
| | | | | (1.55) | | |
| Product B | 20,160 | 0.92 | 124; 1251 | 1157; | 85% | 135 |
| | | | | 1820 | (0.966) | |
| | | | | (1.57) | | |
| Product C | 17,100 | 0.95 | 74; 1114 | 1806; | 85% | 74 |
| | | | | 3284 | (1.442) | |
| | | | | (1.82) | | |
| Product D | 19,020 | 0.91 | 41; 1125 | 3186; | 85% | 178 |
| | | | | 7388 | (2.628) | |
| | | | | (2.32) | | |
| Product E | 5,700 | 0.86 | 19; 645 | 4497; | 85% | 6 |
| | | | | 11434 | (3.251) | |
| | | | | (2.54) | | |

### Specific Process Description for the Preparation of Product A

### Apparatus Employed:

Metal reactor with anchor stirrer; Reactor volume: 2.2 L
Huber thermostat
3 dosage control diaphragm pumps
RAMAN probe

### Procedure:

Water (420.3 g) was poured into the reactor and the reactor was flushed 3 times with nitrogen at 5 bar. Subsequently, the water was heated to the desired reaction temperature of 95° C. Once the water had reached the desired temperature 10.0 g of sodium hypophosphite solution (40% weight/weight) was dosed into the reactor. After dosing the sodium hypophosphite into the reactor 2.7 g of sodium persulfate (7% weight/weight) was dosed into the reactor. This dosing of the sodium hypophosphite and sodium persulfate was referred to as a preload. Subsequently, 298.9 g of sodium hypophosphite solution (40% weight/weight) was fed into the reactor through feed inlet 1 over the period 5 hours 35 minutes, 1251.0 g of acrylic acid was fed into the reactor through feed inlet 2 over the period 6 hours 5 minutes and 188.0 g of sodium sulfate solution (7% weight/weight) was fed into the reactor through feed inlet 3 over the period 6 hours 20 minutes. The 3 feeds were commenced simultaneously. The sodium hypophosphite solution feed was controlled using the Raman probe ensuring a constant dosing over the period of dosing. The acrylic acid dosing was set to give a ratio control of 58.5% of the hypophosphite content over the period of feeding the acrylic acid into the reactor. The dosing strategy of the sodium persulfate set a ratio control of 14.36% of the acrylic acid content over the period of dosing of the sodium persulfate. The temperature was maintained at 95° C. throughout the process. The stirrer speed was maintained at 150 rpm until the feed of the acrylic acid had terminated after which the stirrer speed was increased to 210 rpm.

### Specific Process Description for the Preparation of Product B

### Apparatus Employed:

Metal reactor with anchor stirrer; Reactor volume: 2.2 L
Huber thermostat
3 dosage control diaphragm pumps

### Procedure:

Water (421.0 g) was poured into the reactor and the reactor was flushed 3 times with nitrogen at 5 bar. Subsequently, the water was heated to the desired reaction temperature of 95° C. Once the water had reached the desired temperature 10.2 g of sodium hypophosphite solution (40% weight/weight) was dosed into the reactor. After dosing the sodium hypophosphite into the reactor 2.7 g of sodium persulfate (7% weight/weight) was dosed into the reactor. This dosing of the sodium hypophosphite and sodium persulfate was referred to as a preload. Subsequently, 298.8 g of sodium hypophosphite solution (40% weight/weight) was fed into the reactor through feed inlet 1 over the period 5 hours 36 minutes, 1251.4 g of acrylic acid was fed into the reactor through feed inlet 2 over the period 6 hours 5 minutes and 188.0 g of sodium sulfate solution (7% weight/weight) was fed into the reactor through feed inlet 3 over the period 6 hours 20 minutes. The 3 feeds were commenced simultaneously. The sodium hypophosphite solution acrylic acid and sodium persulfate where each fed into the reactor delivering maintaining constant feed rates over the respective dosing periods. The temperature was maintained at 95° C. throughout the process. The stirrer speed was maintained at 150 rpm until the feed of the acrylic acid had terminated after which the stirrer speed was increased to 180 rpm.

Products C to E were prepared in an analogous fashion to Product B.

Further polymer samples were prepared by a different process employing acrylic acid, sodium bisulphite and sodium persulphate. The mass of acrylic acid, sodium bisulphite and sodium persulphate given in Table 3

TABLE 3

| | | Sodium Bisul- | Sodium persul- | |
|---|---|---|---|---|
| | Acrylic | phite (g); [%] | phate (g); [%] | Mn; Mw |
| Polymer | Acid | based on mass | based on mass | [g/mol] |
| Sample | (g) | of acrylic acid | of acrylic acid | (PDI) |
| Product F | 1006.30 | 187.0; [18.58] | 10.269; [1.02] | 1033; 3284 |
| | | | | (3.18) |
| Product G | 1140.40 | 120.04; [10.53] | 11.627; [1.02] | 1849; 3865 |
| | | | | (2.09) |
| Product H | 600.275 | 42.6904; [7.11] | 6.128; [1.02] | 2917; 6929 |
| | | | | (2.38) |

All 3 polymer samples Product F, Product G and Product H are comparative.

A further comparative polymer sample included a commercial product—(Product X) polyacrylic acid prepared using hypophosphite but not by the process required by the present invention having Mn of approximately 1250 g/mol, M_{w} of approximately 2460 g/mol and PDI of approximately 2.0.

A further comparative polymer sample included a commercial product (Product Y)—polyacrylic acid prepared using sulphite and not by the process required according to the present invention having Mn of approximately 1050 g/mol, M_{w} of approximately 2050 g/mol and PDI of approximately 2.0.

### Example 1

### Application Test Work

Stock solutions were prepared from all of the polymer samples with an active ingredient concentration of 0.1% prepared in deionised water and adjusted to a pH of 7.0 with dilute sodium hydroxide solution.

### Test 1—Calcium Sulfate Scale Inhibition Test

A solution of NaCl, Na₂SO₄, CaCl2) and polymer was shaken 24 h at 70° C. in the water bath. After filtration of the still warm solution via a 0.45 micron milex filter, the Ca content of the filtrate is determined in a complexometric or by means of a Ca²⁺ selective electrode and by comparison before/after the CaSO₄ inhibition in % is determined (see formula I).

Conditions

| Ca | 2-2940 | mg/l |
|---|---|---|
| SO₄²⁻ | 7200 | mg/l |
| Na⁺ | 6400 | mg/l |
| Cl⁻ | 9700 | mg/l |
| Polymer | 5 mg/l (100% ig) | |
| Temperature | 90° | C. |
| Time | 24 | hours |

| | |
|---|---|
| pH | 8.0-8.5 |

$${CaSO}_{4} - Inhibition [ \% ] = \frac{( mg {( CaO )}_{{Sample ( 24 h )}^{-}} mg {( CaO )}_{Blank Value ( 24 h )} )}{( mg {( CaO )}_{{Sample ( 0 h )}^{-}} mg {( CaO )}_{Blank Value ( 24 h )} )} * 100 \qquad Formula I$$

### Test 2—Calcium Carbonate Scale Inhibition Test

A solution of NaHCO₃, Mg₂SO₄, CaCl2) and polymer is shaken 2 h at 70° C. in the water bath. After filtration of the still warm solution via a 0.45 micron milex filter, the Ca content of the filtrate is determined complexometric or by means of a Ca²⁺-selective electrode and determined by comparison before/after the CaCO₃ inhibition in % (see formula II).

| Ca | 2-215 | mg/L |
|---|---|---|
| Mg²⁺ | 43 | mg/L |
| HCO₃⁻ | 1220 | mg/L |
| Na⁺ | 460 | mg/L |
| Cl⁻ | 380 | mg/L |
| SO₄²⁻ | 170 | mg/L |
| Polymer | 3 mg/L (100% ig) | |
| Temperature | 70° | C. |
| Time | 2 | hours |

| | |
|---|---|
| pH | 8.0-8.5 |

$${CaCO}_{3} - Inhibition [ \% ] = \frac{( mg {( CaO )}_{{Sample ( 2 h )}^{-}} mg {( CaO )}_{Blank Value ( 2 h )} )}{( mg {( CaO )}_{{Sample ( 0 h )}^{-}} mg {( CaO )}_{Blank Value ( 2 h )} )} * 100 \qquad Formula II$$

The following tests 3-6 evaluate the dispersion capability of certain crystalline particles in water to establish that dispersibility is not adversely affected.

### Test 3—Calcium Carbonate Dispersion Test

First, by merging solutions and 100.00 g/L CaCl2)*6H₂O and 48.40 g/L Na₂CO₃ pure calcium carbonate is precipitated and then separated via a white-band filter paper.

10.0 g of CaCO₃ (<100 microns) are stirred into tap water of 10° dH, which contains 12.5 ppm of the polymer to be tested for 10 minutes. In a 1 L measuring cylinder, the limit, the turbidity to clear water, is read immediately and after 3 hours.

$${CaCO}_{3} - Dispersion [ \% ] = \frac{Value at 3 h}{10} \qquad Formula III$$

### Test 4—Iron Oxide—Dispersion Test

0.1 g Fe₂O₃ is stirred into tap water of 10° dH, which contains 20 ppm of the polymer to be tested for 10 minutes. In a 100 mL measuring cylinder, the turbidity is determined immediately and after 1 hour by means of a turbidity measuring device in NTU (Nephelometric Turbidity Unit).

$${Fe}^{3 +} - Dispersion [ \% ] = \frac{Value at 1 h}{Value at t = 0} * 100 \% \qquad Formula IV$$

### Test 5—Kaolin—Dispersion Test

0.1 g kaolin is stirred in fully desalinated water, which contains 20 ppm of the polymer to be tested for 10 minutes. In a 100 mL measuring cylinder, the turbidity is determined immediately and after 1 hour by means of a turbidity measuring device in NTU (Nephelometric Turbidity Unit).

$$Kaolin - Dispersion [ \% ] = \frac{Value at 1 h}{Value at t = 0} * 100 \% \qquad Formula V$$

### Test 6—Hydroxyapatite Dispersion Test

0.6 g Ca₅(PO₄)₃OH are stirred into tap water of 10° dH, which contains 100 ppm of the polymer to be tested for 10 minutes. In a 100 mL measuring cylinder, the turbidity is determined immediately and after 1 hour by means of a turbidity measuring device in NTU (Nephelometric Turbidity Unit).

$$Hydroxylapatite - Dispersion [ \% ] = \frac{Value at 1 h}{F actor {2.29}^{⋆}} \qquad Formula VI$$

$${}^{*} E xternal standard = 229 / 200$$

Results Test 1-6 are presented in Table 4

TABLE 4

| | Inhibition (%) | | Dispersion (%) | | | |
|---|---|---|---|---|---|---|
| | Dosage | | | | | |
| | 5 ppm | 3 ppm | 20 ppm | 20 ppm | 100 ppm | 12.5 ppm |
| | Test | | | | | |
| | 1 | 2 | 4 | 5 | 6 | 3 |
| | Type of Covering | | | | | |
| | | | | | | CaCO₃ |
| Polymer Sample | CaSO₄ | CaCO₃ | Fe₂O₃ | Kaolin | Apatite | (3 h) |
| Product X | 70 | 91 | 25 | 53 | 28 | 66 |
| Product F | 71 | 93 | 44 | 52 | 25 | 69 |
| Product A | 97 | 98 | 43 | 44 | 36 | 66 |
| Product B | 96 | 100 | 42 | 46 | 27 | 50 |
| Product C | 57 | 85 | 37 | 48 | 27 | 67 |
| Product G | 51 | 74 | 36 | 47 | 19 | 58 |
| Product H | 46 | 57 | 25 | 54 | 14 | 61 |
| Product D | 48 | 64 | 24 | 51 | 17 | 62 |
| Product E | 47 | 54 | 28 | 53 | 6 | 56 |

### Summary of Tests 1-6

Polymers according to the invention Product A and Product B with a molecular weight M_{w} 1500-3000 g/mol and prepared by the process employing hypophosphite exhibiting a molar ratio [AA]/[P—H] over a time period in which at least 75% of the acrylic acid is converted and has a value x which is constant to within ±0.5 and is in the range from 0.8 to 2 show a significantly improved inhibition of calcium sulfate and calcium carbonate by comparison to polymers prepared by the analogous process steps using hypophosphite but having molecular weight M_{w} above the claimed range of 3000 g/mol or polymers not prepared by the analogous process steps of the invention. It is also evident that the polymers according to the invention Product A and Product B show improved Fe₂O₃ dispersions by comparison to the comparative tests. In all other tests, the inventive polymers Product A and Product B show a similar good effect as comparative polymers.

### Example 2

### Experiments for Inhibiting Basic Ca/Mg Salt Deposits (DSL Method) in Saline Aqueous Systems

The plaque-inhibiting effect of the polymers of the invention is carried out with the help of a modified version of the “Differential Scale Loop (DSL)” device of PSL Systemtechnik. This is a “tube blocking system” as a fully automated laboratory system for the investigation of precipitations and deposits of salts in pipelines and water pipes. In this device, a calcium/magnesium chloride solution A with a sodium bicarbonate solution B containing the polymer to be tested is mixed in modified mode of operation at a temperature of 110° C. and a specific pressure of 2 bar at a mixing point in the volume ratio 1:1 and pumped through a test capillary of stainless steel at constant temperature, with constant flow rate. Here, the differential pressure between the mixing point (capillary beginning) and the capillary end is determined. An increase in differential pressure indicates the formation of plaques by basic calcium/magnesium salts (aragonite, hydromagnesite, brucite) within the capillaries. The time measured up to a pressure increase of defined height (0.1 bar) is a measure of the plaque inhibitory effect of the polymer used.

The specific test conditions are:

Test Solution A:

| | | |
|---|---|---|
| CaCl₂•2H₂O | 4.41 | g/L |
| MgCl₂•6H₂O | 30.16 | g/L |
| KCl | 1.13 | g/L |
| NaCl | 29.466 | g/L |

Test Solution B:

| | | |
|---|---|---|
| NaHCO₃ | 1.01 | g/L |
| Na₂CO₃ | 0.491 | g/L |
| KCl | 1.13 | g/L |
| Na₂SO₄ | 11.63 | g/L |
| NaCl | 29.466 | g/L |

As a result:

| | | |
|---|---|---|
| Salinity: | 45,000 | ppm |
| Ca²⁺ | 600 | ppm |
| Mg²⁺ | 1800 | ppm |
| HCO₃⁻ | 370 | ppm |

| | |
|---|---|
| pH | 8.5 |

Concentration of the polymer after mixing A and B: 2 mg/l (100%)

| Capillary length: | 2 | m |
|---|---|---|
| Capillary diameter: | 0.75 | mm |
| Capillary | material: stainless steel | |
| Temperature: | 110° | C. |
| Total flow rate: | 5 | ml/min |
| System pressure: | 2 | bar |
| Pressure rise threshold: | 0.1 | bar |
| Max. Test duration: | 300 | min. |

### Results

The results showing the time to pressure increase for each test is shown in Table 5.

TABLE 5

| | Time to pressure increase by 0.1 bar in |
|---|---|
| Polymer Sample | minutes |
| Without polymer | 60 |
| Modified polycarboxylate | 180 |
| Product Y | 90 |
| Product X | 250 |
| Product A | >300 |

The polymer sample according to the invention Product A shows the best inhibition of scale coating formation as it reaches the maximum test duration of 300 minutes by comparison to the blank or the comparative products.

### Polymers Used in Example 3

The following acrylic acid polymer samples were prepared by polymerising acrylic acid by the process specified in the examples of WO 2017134128 given on pages 13-15 with the, sodium hypophosphite (SHP) and sodium persulphate given in Table 1 and specific procedure parameters and polymer characteristics are provided in Table 2.

TABLE 6

| | SHP [%] based | Sodium persulphate | | |
|---|---|---|---|---|
| Polymer | on mass of | [%] based on mass of | Mw | PDI |
| Sample | acrylic acid | acrylic acid | (g/mol) | (Mw/Mn) |
| Product A | As shown in Table 1 and 2 | | | |
| Product J | 6.5 | 1.0 | 1160 | 1.9 |
| Product K | 6.63 | 1.10 | 3165 | 1.9 |

| | |
|---|---|
| Product D | As shown in Table 1 and 2 |

Product A and Product J are both polymers of acrylic acid that would fall into the scope of claim 1. Product J was prepared by controlling the acrylic acid feed employing a Raman probe analogously to Product A. Product J was prepared at a temperature of 108° ° C. which was higher than the temperature employed producing Product A resulting in a lower weight average molecular weight (M_{w}). The ratio of [AA]/[P—H] for at least 75% conversion of the acrylic acid for Product J was expected to be in the range of 0.8-2.0.

The remaining 2 polymer samples Product K and Product D are comparative.

Further polymer sample was prepared by a different process employing acrylic acid, sodium bisulphite and sodium persulphate. The mass of acrylic acid, sodium bisulphite and sodium persulphate given in Table 7

TABLE 7

| | Sodium | Sodium persulphate | | |
|---|---|---|---|---|
| | Bisulphite [%] | [%] based | | |
| Polymer | based on mass of | on mass of | Mw | PDI |
| Sample | acrylic acid | acrylic acid | (g/mol) | (Mw/Mn) |
| Product L | 7.11 | 1.02 | 6171 | |

Polymer sample Product L is comparative.

A further comparative polymer sample included a commercial product (Product Z) polyacrylic acid prepared using bisulfite and not by the process required according to the present invention having M_{w} of approximately 5000 g/mol and PDI of approximately 2.4.

### Example 3

### Application Test Work

Stock solutions of the polymer samples were prepared in accordance with Example 1.

### Test 1—Calcium Sulfate Scale Inhibition Test

Testing solutions: Ultrapure water was always used as water Polymer solution 0.1%, adjusted to pH 7.0 by NaOH or HCl

Solution I

| | |
|---|---|
| 15.00 g | NaCl |
| 42.60 g | Na₂SO₄ |

Filled with water to 2 L

Solution II

| | | |
|---|---|---|
| 15 | g | NaCl |
| 43.22 | g | CaCl₂ * 2 H₂O |

Filled with water to 2 L
Buffer solution pH 10

| | | |
|---|---|---|
| 108 | g | NH₄Cl |
| 700 | mL | NH₄OH (25% ig) |

filled with water to 2 L
Conditioning solution Ca-ISE

| | | |
|---|---|---|
| 0.277 | g | CaCl₂ |

filled with water to 250 ml

### Performance

A triple determination was carried out of each polymer. 50 g of solution I was put in to a 180 mL PE cup. 500 μL of the 0.1% polymer solution was added (5 ppm in the complete test solution) and 50 g of solution II was added. 1 mL of the sample solution was added to 100 mL of ultrapure water and the Ca²⁺ quantity was determined by titration. The sample was closed and stored at the desired test temperature for 24 hours and 70 rpm. After 24 h, the cup was removed from the water bath and immediately about 10 mL of the warm solution with a disposable syringe filtered via a Milex filter (0.45 μm) into a penicillin glass. 1 mL of the filtered solution was analyzed by titration.

$${CaSO}_{4} - Inhibition [ \% ] = \frac{( mg {( CaO )}_{{Sample ( 24 h )}^{-}} mg {( CaO )}_{Blank Value ( 24 h )} )}{( mg {( CaO )}_{{Sample ( 0 h )}^{-}} mg {( CaO )}_{Blank Value ( 24 h )} )} * 100 \qquad Formula I$$

### Test 2—Calcium Carbonate Scale Inhibition Test

Testing solutions: Ultrapure water was always used as water.

Polymer solution 0.1%, adjusted to pH 7.0 by NaOH or HCl.

Solution I

| | | |
|---|---|---|
| 3.154 | g | CaCl₂ * 2 H₂O |
| 1.76 | g | MgSO₄ * 7 H₂O |

Filled with water to 2 L

Solution II

| | | |
|---|---|---|
| 6.72 | g | NaHCO₃ |

filled with water to 2 L
Buffer solution pH 10

| | | |
|---|---|---|
| 108 | g | NH₄Cl |
| 700 | mL | NH₄OH (25% ig) |

Filled with water to 2 L
Conditioning solution Ca-ISE

| | | |
|---|---|---|
| 0.277 | g | CaCl₂ |

Filled with water to 250 ml

### Performance

A triple determination was carried out of each polymer. 50 g of solution I was put into a 180 mL PE cup. 300 μL of the 0.1% polymer solution was added (3 ppm in the complete test solution) and 50 g of solution II was added. 5 mL of the sample solution was added to 100 mL of ultrapure water and the Ca²⁺ quantity was determined by titration. The sample was closed and stored at the desired test temperature for 2 hours and shaken at 70 movements per minute. After 2 h, the cup was removed from the water bath and immediately about 10 mL of the warm solution with a disposable syringe filtered via a Milex filter (0.45 μm) into a penicillin glass. 5 mL of the filtered solution was analyzed by titration.

### Test 3—Calcium Carbonate Dispersion Test

### Producing the Precipitated Calcium Carbonate Dispersion

Solution A: 67.12 g CaCa₂*2H₂O were dissolved in 400 mL of ultrapure water. After dissolving, the solution was made up to 1000 g with ultrapure water.

Solution B: 48.40 g Na₂CO₃ were dissolved in 400 mL ultrapure water. After dissolving, the solution was made up to 1000 g with ultrapure water.

Precipitation: Solution A was poured into a 3 L beaker and stirred at about 600 rpm. To this Solution B was added. The combined solution was filtered through a white band filter. The so formed filter cake was dried at 125° C. for at least 2 hours. Thereafter the filter cake was crushed. Sieve the powder for 10 minutes (amplitude 1.50) employing sieve set 400 μm, 200 μm, 100 μm.

Method: 1000 g of water (10° dH) were poured into a 2 L beaker. 1.25 mL of the 1% polymer solution (12.5 ppm based on CaCO₃) was added to the water. The CaCO₃ was added to the water and stirred for 10 minutes at about 500 rpm. After the time had elapsed, the solution was transferred into a 1 L measuring cylinder. Immediately after 3 hours the limit of turbidity/water was measured.

$${CaCO}_{3} - Dispersion [ \% ] = \frac{Value at 3 h}{10} \qquad Formula III$$

### Test 4—Iron Oxide—Dispersion Test

Method: 0.1 g iron (III) oxide was placed in a 150 mL beaker and 98 mL of water (10° dH) was added. The beaker was based on a magnetic stirrer and the contents stirred at 700 rpm. The solution of the polymer to be tested was added (20 ppm or 2.0 mL of the 0.1% polymer solution). The solution was stirred for 10 minutes. Shortly before the time had elapsed, 1 mL of the sample solution was removed and transferred to a 10 mL round cuvette (11 mm) and filled with 4 mL of ultrapure water. A measurement was determined immediately using a Hach Lange 2100AN Turbidmeter. The solution was transferred into 100 mL mixing cylinder and closed. After one hour at 80 mL, a 1 mL sample was taken.

$${Fe}^{3 +} - Dispersion [ \% ] = \frac{Value at 1 h}{Value at t = 0} * 100 \% \qquad Formula IV$$

### Test 5—Kaolin—Dispersion Test

Method: 0.1 g kaolin (“Speswhite”)/(“OT 82”) were added to a 150 mL beaker (Haiphong) to which 98 mL of ultrapure water were added. The beaker was placed on a magnetic stirrer and the contents stirred at 700 rpm. A solution of polymer to be tested (20 ppm or 2.0 mL of the 0.1% polymer solution) was added to the mixture. This was stirred for 10 minutes. Shortly before the time had elapsed, 1 mL of the sample mixture was removed and transferred to a 10 mL round cuvette (11 mm) and filled with 4 mL of ultrapure water. A measurement was determined immediately using a Hach Lange 2100AN Turbidmeter. The solution was transferred into 100 mL mixing cylinder and closed. After one hour at 80 mL, a 1 mL sample was taken.

### Formula V:

$$Kaolin - Dispersion [ \% ] = \frac{Value at 1 h}{Value at t = 0} * 100 \%$$

### Test 6—Hydroxyapatite—Dispersion Test

0.6 g hydroxyapatite was placed in a 150 mL beaker (high form) and 99 mL of water (10° dH) were added to it. The beaker was placed on a magnetic stirrer and the contents stirred at 700 rpm. A solution of the polymer to be tested (100 PPM or 1.0 mL of the 1.0% polymer solution) was added to the mixture. This mixture was stirred for 10 minutes. Shortly before the time had elapsed, 1 mL of the sample mixture was removed and transferred to a 10 mL round cuvette (11 mm) and filled with 4 mL of ultrapure water. A measurement was determined immediately using a Hach Lange 2100AN Turbidmeter. The solution was transferred into 100 mL mixing cylinder and closed. After one hour at 80 mL, a 1 mL sample was taken.

### Formula VI:

$$Hydroxylapatite - Dispersion [ \% ] = \frac{Value at 1 h}{F actor {2.29}^{⋆}}$$

$${}^{*} E xternal standard = 229 / 200$$

Results Test 1-6 are presented in Tables 8-14

TABLE 8

| | |
|---|---|
| CaSO4 Inhib. | Calcium Sulphate Inhibition [%] |

| 5 ppm Polymer | 70° C. | 80° C. | 90° C. | 95° C. |
|---|---|---|---|---|
| Product Z | 17% | 13% | 9% | 8% |
| Product D | 18% | 14% | 9% | 7% |
| Product K | 32% | 16% | 12% | 12% |
| Product J | 78% | 31% | 26% | 14% |
| Product L | 22% | 13% | 10% | 9% |
| Product A | 71% | 24% | 18% | 14% |

TABLE 9

| | |
|---|---|
| CaCO3 Inhib. | Calcium Carbonate Inhibition [%] |

| 3 ppm Polymer | 70° C. | 80° C. | 90° C. | 95° C. |
|---|---|---|---|---|
| Product Z | 64% | 38% | 45% | 33% |
| Product D | 64% | 30% | 39% | 30% |
| Product K | 80% | 52% | 58% | 42% |
| Product J | 86% | 67% | 72% | 54% |
| Product L | 68% | 38% | 48% | 35% |
| Product A | 84% | 65% | 69% | 52% |

TABLE 10
Calcium Carbonate Dispersion

| Polymer | | | | | | | |
|---|---|---|---|---|---|---|---|
| 12.5 ppm | Blank | Product Z | Product D | Product K | Product J | Product L | Product A |
| Instant value | 100 | 100 | 100 | 100 | 100 | 100 | 100 |
| Value at 3 h | 100 | 700 | 620 | 650 | 650 | 610 | 620 |
| % | 10 | 70 | 62 | 65 | 65 | 61 | 62 |

TABLE 11
Iron Oxide Dispersion

| Polymer | | | | | | | |
|---|---|---|---|---|---|---|---|
| 20 ppm | Blank | Product Z | Product D | Product K | Product J | Product L | Product A |
| Instant value | 751 | 915 | 719 | 936 | 828 | 610 | 647 |
| Value at 1 h | 173 | 470 | 358 | 489 | 485 | 313 | 376 |
| % | 23 | 51 | 50 | 52 | 59 | 51 | 58 |

TABLE 12
Kaolin: Speswhite, Imerys

| Polymer | | | | | | | |
|---|---|---|---|---|---|---|---|
| 20 ppm | Blank | Product Z | Product D | Product K | Product J | Product L | Product A |
| Instant value | 58.4 | 73.9 | 80.3 | 71.9 | 69.9 | 82.1 | 72.5 |
| Value at 1 h | 22.7 | 53.1 | 60.7 | 54.9 | 51 | 64.9 | 56.4 |
| Dispersibility | 39 | 72 | 76 | 76 | 73 | 79 | 78 |
| [%] | | | | | | | |

TABLE 13
Kaolin: OT 82, Sedlecky

| Polymer | | | | | | | |
|---|---|---|---|---|---|---|---|
| 20 ppm | Blank | Product Z | Product D | Product K | Product J | Product L | Product A |
| Instant value | 59 | 58.9 | 60 | 58.1 | 63.8 | 58.1 | 59.2 |
| Value at 1 h | 32.2 | 40.1 | 50.5 | 45.8 | 43.6 | 46.7 | 50.1 |
| Dispersibility | 55 | 68 | 84 | 79 | 68 | 80 | 85 |
| [%] | | | | | | | |

TABLE 14
Calcium hydroxyapatite

| Polymer | | | | | | | |
|---|---|---|---|---|---|---|---|
| 100 ppm | Blank | Product Z | Product D | Product K | Product J | Product L | Product A |
| Instant value | 248 | 264 | 271 | 265 | 264 | 271 | 266 |
| Value of 1 h | 3.51 | 61.1 | 75.7 | 73.5 | 78.7 | 65.8 | 87.4 |
| % | 2 | 27 | 33 | 32 | 34 | 29 | 38 |

The results shown in Tables 8 and 9 illustrate the inventive copolymers Products A and J provide improved scale inhibition for both calcium sulfate and calcium carbonate respectively at each of the temperatures 70° C., 80° C., 90° C. and 95° C. by comparison to the comparative products. This trend can clearly be seen for both inventive products.

The Results presented in Tables 10-14 also showed that the inventive products, Products A and J, exhibited good dispersibilities for a range of inorganic substrates, and comparable with the comparative products.

1. (canceled)

2. The process according to claim 25 for inhibiting scale formation resulting from calcium salts and/or magnesium salts present in the desalination system.

3. The process according to claim 25, for inhibiting the scale formation from calcium sulfate present in the desalination system.

4. The process according to claim 25, wherein the desalination system is a high temperature desalination system.

5. The process according to claim 25, wherein the desalination system is run at a temperature which is at least 10% higher than the standard mean temperature adopted for that desalination system.

6. The process according to claim 25, wherein the desalination system comprises at least one Multi Stage Flash (MSF) process which is operated at a temperature of at least 120° C.

7. The process according to claim 25, wherein the desalination system comprises at least one Multi Effect Distillation (MED) process which is operated at a temperature of at least 80° C. and more preferably at least 90° C.

8. The process according to claim 25, wherein the desalination system is a Reverse Osmosis (RO) desalination system comprising a Reverse Osmosis (RO) membrane.

9. The process according to claim 25, wherein step (i) includes initiator.

10. The process according to claim 25, wherein step (i) does not include any acrylic acid or one or more ethylenically unsaturated comonomer.

11. The process according to claim 25, wherein said process of polymerising acrylic acid comprises adding continuously at a constant or varying dosing rate or discontinuously a total amount m1 of acrylic acid over a time period (t1−t1.0), a total amount m2 of free radical starter solution over a time period (t2−t2.0), and a total amount m3 of aqueous hypophosphite solution over a time period (t3−t3.0) and the polymerisation takes place in a time period (t4−t4.0), wherein time points t1.0, t2.0, and t3.0 determine a start of the respective feeds and t4.0 determines commencement of the polymerisation.

12. The process according to claim 25, wherein a time average dosing time point for the hypophosphite solution
$${\overline{t}}_{dosing} = \frac{1}{m 3} {\int }_{t 3.}^{t 3} ( d ( t ) * t ) dt$$
is 0.3 to 0.47 times a total feed time for the acrylic acid (t1−t1.0).p

13. The process according to claim 25, wherein the molar ratio x of acrylic acid to phosphorus-bound hydrogen [AA]/[P—H] over a time period in which at least 75% of the acrylic acid is converted is 1.0±0.5.

14. The process according to claim 25, wherein the total feed time for the hypophosphite solution t3−t3.0 is 80 to 500 min.

15. The process according to claim 25, wherein all feeds commenced simultaneously.

16. The process according to claim 25, wherein a total amount of hypophosphite solution added during the process of polymerising the acrylic acid is at least 7.5% based on the dry weight of hypophosphite on a dry weight of acrylic acid.

17. The process according to claim 25, wherein up to 30 wt. % of comonomer selected from the group consisting of methacrylic acid, maleic acid, maleic anhydride, vinyl sulfonic acid, allyl sulfonic acid, and 2-acrylamido-2-methyl propane sulfonic acid are copolymerised.

18. The process according to claim 25, wherein the polymerisation is carried out under an inert gas atmosphere.

19. The process according to claim 25, wherein the aqueous solution of acrylic acid polymer has a total phosphorus content of organically and optionally inorganically bound phosphorus, wherein
(a) a first part of the phosphorus is present in the form of phosphinate groups bound in the polymer chain,
(b) a second part of the phosphorus is present in the form of phosphinate and/or phosphonate groups bound at the polymer chain end,
(c) optionally third part of the phosphorus is present in the form of dissolved inorganic salts of phosphorus,
wherein at least 86% of the total phosphorus content is present in the form of phosphinate or phosphonate groups bound in the polymer chain or at the chain end of the acrylic acid polymer.

20. The process according to claim 25, wherein the acrylic acid polymer has a K value of no more than 18.

21. The process according to claim 25, wherein the amount of dissolved inorganic salts of phosphorus based on the content of the polymer is ≤0.5%.

22. The process according to claim 25, wherein the polydispersity index of the acrylic acid polymer Mw/Mn is ≤2.0.

23. The process according to claim 25, wherein the acrylic acid polymer obtained by a process of polymerising acrylic acid in feed operation with a free radical starter in the presence of hypophosphite in water as solvent, which comprises
(i) initially charging water and the aqueous hypophosphite solution and optionally the initiator,
(ii) adding acrylic acid in acidic, unneutralised form, optionally one or more ethylenically unsaturated comonomer, aqueous free radical starter solution, and aqueous hypophosphite solution,
(iii) adding a base to the aqueous solution after termination of the acrylic acid feed,
wherein the comonomer content does not exceed 30 wt. % based on the total monomer content, wherein the acrylic acid, the aqueous free radical starter solution, and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.5 and is in the range from 0.9 to 1.1, preferably 1.0,
wherein the acrylic acid polymer has a weight average molecular mass Mw of from 1000 to 2500 g/mol,
wherein the desalination system comprises at least one of the group consisting of at least one Multi Stage Flash (MSF) which is operated at a temperature of at least 112° C.;
at least one Multi Effect Distillation (MED) which is operated at a temperature of at least 70° C.; and
Reverse Osmosis (RO) comprising a Reverse Osmosis (RO) membrane.

24. The process according to claim 25, wherein the polymer of acrylic acid polymer obtained by a process of polymerising acrylic acid in feed operation with a free radical starter in the presence of hypophosphite in water as solvent, which comprises
(i) initially charging water and the aqueous hypophosphite solution, and the initiator,
(ii) adding acrylic acid in acidic, unneutralised form, optionally one or more ethylenically unsaturated comonomer,
the aqueous free radical starter solution, and the aqueous hypophosphite solution,
(iii) adding a base to the aqueous solution after termination of the acrylic acid feed,
wherein the comonomer content does not exceed 30 wt. % based on the total monomer content, wherein the acrylic acid, the aqueous free radical starter solution and the aqueous hypophosphite solution are added such that the molar ratio x of acrylic acid to phosphorus-bound hydrogen [AA]/[P—H] over a time period in which at least 75% of the acrylic acid is converted and has a value x which is constant to within ±0.25 and is 1.0, wherein the acrylic acid polymer has a weight average molecular mass Mw of from 1000 to 2500 g/mol, wherein the desalination system comprises at least one of the group consisting of Multi Stage Flash (MSF) which is operated at a temperature of at least 120° C.; at least one Multi Effect Distillation (MED) which is operated at a temperature of at least 80° C.; and Reverse Osmosis (RO) comprising a Reverse Osmosis (RO) membrane.

25. A process of desalinating saline water in a desalination system comprising:
a) adding an aqueous solution of acrylic acid polymer for inhibiting scale formation in the desalination system;
b) subjecting the saline water to at least one desalination step,
wherein the acrylic acid polymer obtained by a process of polymerising acrylic acid in a feed operation with a free radical starter in the presence of a hypophosphite in water as solvent, which comprises
(i) initially charging water and an aqueous hypophosphite solution, optionally acrylic acid in acidic, unneutralised form, optionally one or more ethylenically unsaturated comonomer, and optionally an initiator,
(ii) adding acrylic acid in acidic, unneutralised form, optionally one or more ethylenically unsaturated comonomer, aqueous free radical starter solution, and aqueous hypophosphite solution,
(iii) adding a base to the aqueous solution after termination of the acrylic acid feed,
wherein the comonomer content does not exceed 30 wt. % based on a total monomer content, wherein the acrylic acid, the aqueous free radical starter solution, and the aqueous hypophosphite solution are added such that a molar ratio x of acrylic acid to phosphorus-bound hydrogen [AA]/[P—H] over a time period in which at least 75% of the acrylic acid is converted and has a value x which is constant to within ±0.5 and is in a range from 0.8 to 2,
wherein the acrylic acid polymer has a weight average molecular mass Mw from 1000 to 3000 g/mol,
wherein the desalination system comprises at least one of the group consisting of Multi Stage Flash (MSF), at least one Multi Effect Distillation (MED), and Reverse Osmosis (RO).

26. (canceled)
